(19) United States
(12) Patent Application Publication
(10) Pub. No.: US 2026/0145758 A1
(43) Pub. Date: May 28, 2026

(54) A Vehicle and a Vehicle Steering Mechanism for a Vehicle

(71) Applicant: AUTNTIC B.V., Woerden (NL)

(72) Inventors: Martien Jan Pieter VOORBIJ, Pelt (BG); Coen Antonius Adrianus Maria BAIJENS, Pelt (BG)

(73) Assignee: AUTNTIC B.V., Woerden (NL)

(21) Appl. No.: 19/119,868

(22) PCT Filed: Oct. 10, 2023
(86) PCT No.: PCT/EP2023/078067

§ 371 Date: Apr. 10, 2025

(30) Foreign Application Priority Data
Oct. 10, 2022 (NL) 1044437

(51) Int. Cl. B62K 5/10; B62K 21/20

(52) U.S. Cl. CPC B62K 5/10; B62K 21/20

(57) ABSTRACT

A vehicle and in particular a motorized vehicle and/or driven by at least one power source, comprising a rear frame section comprising at least two rear wheels and at least one rear wheel axis and in particular the rear wheel axis essentially vertical with respect to the surface where the rear wheels are connected or connectable with the ground surface, a front frame section comprising at least one front wheel and at least one front wheel axis, wherein the front frame section is connected and/or connectable to the rear frame section via at least one connection, a steering mechanism which is connected and/or connectable to at least the front frame section and which is configured to steer the front wheel.

The present invention relates to a steering mechanism and a vehicle and in particular a motorized vehicle and/or driven by at least one power source, comprising a rear frame section comprising at least two rear wheels and at least one rear wheel axis and in particular the rear wheel axis essentially vertical with respect to the surface where the rear wheels are connected or connectable with the ground surface, a front frame section comprising at least one front wheel and at least one front wheel axis, wherein the front frame section is connected and/or connectable to the rear frame section via at least one connection, a steering mechanism (could also be referred to as steering structure, steering construction or steering unit or steering system) which is connected and/or connectable to at least the front frame section and which is configured to steer the front wheel with respect to at least one front wheel axis and in particular the front wheel axis essentially vertical with respect to the surface where the front wheel is connected or connectable with the ground surface, wherein said steering mechanism comprises at least one steering element, in particular at least one steering wheel, wherein the steering mechanism comprises at least one suspension arm, wherein the suspension arm is connected and/or connectable to the front wheel by an wheel suspension element and on the other side connected and/or connectable to the front frame, wherein the steering mechanism is mechanically or electronically connected and/or connectable to the steering wheel and on the other end rotatably connected and/or rotatably connectable to the wheel suspension element via at least a steering rod, wherein the steering mechanism is configured to transform the angular displacement of the steering wheel in an angular displacement of the front wheel with respect to at least one front wheel axis, wherein the steering mechanism is configured to actuate the steering rod.

A three wheeled tilting vehicle with one front wheel and two rear wheels requires a specific steering mechanism and front suspension.

A known three wheeled tilting vehicle has a mechanical connection between front wheel steering and rear wheel steering and which mechanically triggers tilting. This mechanism has to do with bump steer. An extraordinary complex lever steering mechanism is provided with a power steering mechanism is provided to mask the bump steer effect a bit, but it does not solve it.

Bump steer is the tendency of the wheel of a car to steer itself as it moves through the suspension stroke. Bump steer causes a vehicle to turn itself when one wheel hits a bump or falls down into a hole or rut. Excessive bump steer increases tire wear and makes the vehicle more difficult to handle on rough roads. For example, if the front left wheel rolls over a bump it will compress the suspension on that corner and automatically rotate to the left (toe out), causing the car to turn itself left momentarily without any input from the steering wheel. Another example, is that when most vehicles become airborne their front wheels will noticeably toe in. The impact of bump steer on a tilting three wheeler is bigger than for a conventional four wheeled or three wheeled car which is not configured to tilt by means of an active tilting frame or cabin. A tilting three-wheeler wherein the front wheel is mechanically connected to the steering wheel and wherein the tilting is controlled by torque or steering angle of the steering wheel is driving in for example a hole or rut or other irregular surface.

For a tilting three wheeler there are a couple of base requirements for the steering mechanism and front suspension. One of these requirements includes to avoid bump steer. Other requirements are steering put from the driver by the means of a steering wheel, steering effort from the driver should not exceed the steering effort for driving an ‘average’ passenger car, front suspension should be sufficiently stiff to limit deflection under braking, front suspension should be of such geometry to limit dive under braking and front suspension should be of such mechanical construction that it is compact in design and allows maximum of legroom for driver without using extra vehicle length.

The requirements for the suspension practically outrule the use of a front fork similar to those used in most motorcycles. However, such a fork is not designed for the magnitude of forces which are transferred from the vehicle to the wheels via the front fork. The front fork would no match the requirements for stiffness of the three wheeler vehicle. In case the suspension would allow to compress the front fork in order to damp the forces towards the front wheel, the vehicle would dive downward which could result in dangerous situation when braking during high speeds

To provide enough stiffness a different suspension layout must be considered. The difficulty with such a layout though is to realize a bump-steer free mechanism yet providing anti-dive or limited dive under braking. Known solutions to overcome the bump steer problem, yet this kind of layout does-due to its non-compact design-not provide any legroom and is therefore not feasible for compact design.

In history several steering solutions in combination with a single-sided or double suspension swingarm have been developed for some exclusive motorbikes. Some of these solutions could be suitable for a three wheeled tilting vehicle, but they have several important disadvantages:

A first disadvantage is that the existing solutions have a very wide building envelope in order to allow the required steer-angle, because the swingarm is located very close to the horizontal center plane of the front wheel. This requires a lot space in longitudinal direction, particularly in the area where the driver feet are located.

A second drawback of this solution is complex construction with a lot of rods, pillow balls, and levers. Het third drawback that its difficult to realize the desired steering ratio and as a fourth drawback the interference with the ground at large tilt angles.

On top if this, for a tilting vehicle with electronic control of the tilting behavior of the front frame and the cabin according the present invention according to claim 1 and any other dependent claims, the steering angle or steering torque has direct impact on the tilting behavior. This is not the case in conventional two three or four wheeled vehicles. Therefor also bump steer impacts the tilting behavior when the driver is not intended to steer the vehicle in a certain trajectory. This leads to undesired and unstable actuation of the tilting mechanism during event when tilting is not desired.

In order to overcome these issues of the state of the art, a three wheeled tilting vehicle is provided according to claim 1, wherein the steering rod is movable and/or rotatably connected and/or movable and/or rotatably connectable to the suspension arm. Because the steering rod is connected to the suspension arm, the steering rod will not move the steering wheel in case the front wheels drives in a hole or rut. In other words this configuration is preventing the change of position of the front wheel related to the position of the steering rod when the load and/or position on the front wheel is changing since the joints of the steering rod and suspension arm will not move as a result of steering the front wheel or in case of angular displacement of the front wheel. On top of this the suspension travel has a predefined impact on the caster of the front wheel which stabilizes the steerability of the vehicle under all driving conditions.

Preferably a tiltable vehicle is provided according to the present invention, wherein the vehicle is tiltable and in particular configured for moving at least one person. In case the vehicle with this steering mechanism is provided in a tiltable vehicle, the prevention of bump steer will result in safer and more stable tilting behavior of the vehicle and prevents e.g. undesired and unstable tilting of the cabin of the front frame since the tilting system, especially when the titling is at least partially controlled based on steering angle.

Preferably a tiltable vehicle is provided according to the present invention, wherein preferably said at least two rear wheels are steerable with respect to at least one rear wheel axis. This embodiment is in particular favorable with to obtain a smooth and bump free driving behavior during especially cornering.

Preferably a tiltable vehicle is provided according to the present invention,, wherein the front frame section is preferably configured to tilt the front frame section about at least one tilt axis, wherein the tilt axis extends in particular in longitudinal/axial direction with respect to the front frame section or cabin. This is the most favorable tiltable configuration of the vehicle with the most natural feeling while cornering (similar when driving on a motorbike).

Preferably a tiltable vehicle is provided according to the present invention, wherein a control unit is provided which is configured to electronically control the tilting behavior of the front frame, in particular for example wherein the degree of tilting at a certain speed of the vehicle is controlled by the control system by one or more inputs (e.g. sensors or camera's, information via the cloud from e.g. data providers or other tools to diagnose or measure characteristics of the vehicle and communicate these inputs to the control unit), wherein one of the inputs steering angle of the front wheel about its axis and/or the steering angle of the steering wheel and/or the steering torque applied to the steering wheel. More inputs are possible such as yaw angle, lateral movement and/or acceleration/deceleration of the front frame, condition of the road, real time data over the air or from the cloud etc. This configuration allows to optimize the tilting behavior and without bump steering the tilting can be fully based on steering angle without the side effects of bump steer on the tilting behavior.

Preferably a tiltable vehicle is provided according to the present invention, wherein the suspension arm is a double sided or single side suspension arm. A single sided suspension arm allows to save space for other components and a double sided arm allows to optimize the material used in the suspension arm while keeping an optimal stiffness/strength.

Preferably a tiltable vehicle is provided according to the present invention, wherein the wheel suspension element is connected and/or connectable to the front frame by the means of an upper and/or lower link above the horizontal center plane of the front wheel, wherein the upper and lower links are rotatably connected and/or rotatably connectable to the front frame and the suspension arm. The construction of the upper and lower links are able to compensate dive during e.g. braking of the vehicle.

Preferably a tiltable vehicle is provided according to the present invention, wherein a wheel suspension support is provided which rotatably connects and/or which is rotatably connectable between the wheel suspension element and the suspension arm. This element keeps the wheel suspension in the right position with a predetermined caster angle. In another preferred embodiment the wheel suspension element can be adjusted by an adjustment mechanism in order to change the caster angle to the desired state.

A vehicle according to claim anyone of the preceding claims, further comprises a steering shaft which is mechanically or electronically connected and/or connectable to the steering wheel and on the other end rotatably connected and/or rotatably connectable to the wheel suspension element element via the steering rod, wherein the steering mechanism is configured to actuate the steering rod and steering shaft, wherein the steering shaft and steering rod are movable or rotatably connected and/or movable or rotatably connectable to the suspension arm. This construction gives enables to mitigate bump steer and wherein the steering shaft is as well configured to compensate dive during braking (i.e. the steering column/shaft will move a bit in during especially a strong deceleration of the vehicle).

Preferably a tiltable vehicle is provided according to the present invention, wherein the steering rod is actuated by means of an pitman arm, wherein the pitman arm is rotationally connected and/or connectable to the steering rod and rotationally connected and/or connectable to the suspension arm. This arrangement provides a smooth movement of the suspension arm under load and at the same time an outrule of bump steer.

Preferably a tiltable vehicle is provided according to the present invention, wherein the steering rod and pitman arm are actuated by means of an steering actuation unit (also referred as actuation system)and wherein the steering mechanism is connected to the suspension arm. The actuation unit is preferably suitable to be electrically supported. This arrangement is energy friendly and the position of the steering mechanism saves leg space.

Preferably a tiltable vehicle is provided according to the present invention, wherein the suspension arm is positioned under an angle between 40-50 degrees with respect to the surface formed by the lowest points of the front and rear wheels and preferably under an angle of 45 degrees with respect to the a the surface formed by the lowest points of the front and rear wheels. This is an optimal solution with optimal legroom and stiffness of the construction of the steering mechanism.

Preferably a tiltable vehicle is provided according to the present invention, wherein the steering actuation unit comprises a steering box, wherein the steering box is integrated with the suspension arm, wherein the steering box comprises a steering box reduction, wherein the steering box reduction is connected to the steering wheel and to the wheels by means of the steering shaft, wherein the steering box reduction is configured to provide a steering reduction between the steering wheel and the steering rod or between the steering wheel and the and the steering rod via the pitman arm. This solution supports the present invention to optimally prevent bump steer (preventing turning of the steering wheel when the front wheel drives into a gap in the rode or other irregularity. In other words, Preventing the change of position of the front wheel related to the position of the steering wheel when the load and/or position on the front wheel is changing). Besides this, this electric steering solution provides a smooth and environmental friendly actuation method since this type of actuation can be actuated by an electric motor with a battery as energy supply.

It is preferred that a tilting vehicle is provided according to the present invention, wherein the steering box reduction of the tilting vehicle comprises a wormshaft and a wormwheel. In this manner a ratio can be achieved between the angular displacement of the steering wheel and the angular displacement of the wheels which enable more comfortable steering.

It is preferred that a tilting vehicle is provided according to the present invention, wherein the steering shaft is telescopic which enable

s to provide a steering actuation of the front wheel in a simple and compact manner.

It is preferred that a tilting vehicle is provided, wherein the telescopic steering shaft connects the wormshaft directly to the steering wheel or to the output shaft of the EPAS (Electric Powered Assisted Steering) system. This is practical and cost effective. The telescopic steering shaft may be supported by an hydraulic, pneumatic, electronic or mechanical arrangement.

It is preferred that a tiltable vehicle is provided according to the present invention, wherein the steering rod is connected to the front wheel or wheel suspension element element by means of an ball joint and to the suspension arm by means of a ball joint, wherein one of the two ball joints is an upper ball joint and the other ball joint the lower ball joint, wherein the relative longitudinal position of the lower ball-joint versus the upper ball-joint determines the caster angle. It's a very convenient solution where the caster angle does not uncontrolled vary under various suspension loads and thus the drivability an steerability of the vehicle is improved.

Preferably a tiltable vehicle is provided according to the present invention with the upper and lower link are positioned such that they having a joint ‘instantaneous center of rotation’. This means that the This makes anti dive possible in a range between 0 and 100 percent. Anti dive is zero when the ‘instantaneous center of rotation’ at the same height as the center of gravity of the vehicle. Dive of the vehicle is to a certain extend desired to provide the drive dynamic feedback about e.g. deceleration of the vehicle. In order to provide a certain level of dive the ‘instantaneous center of rotation’ is below the center of gravity of the vehicle. A preferred embodiment could be to choose the ‘instantaneous center of rotation’ such that 50% antidive is achieved

Preferably a tiltable vehicle is provided according to the present invention, wherein the upper and lower link have a different length, wherein preferably the upper link is shorter than the lower link. This solution compensating or reducing or minimizing or even mitigating the change in caster in a predefined and controlled manner during driving and especially during deceleration or braking events of the vehicle. This improves the steerability of the vehicle especially during braking or deceleration events of the vehicle.

Preferably a tiltable vehicle is provided according to the present invention, wherein the lower link is connected via shock absorber to the front frame of the vehicle. This improves the driving comfort.

Preferably a tiltable vehicle according to the present invention is provided, wherein the tilting of the tilting vehicle is determined at least by the steering angle of the front wheel about its axis. The steering mechanism solution as provided according to the present invention is essential in a vehicle with at least three wheels when the steering angle contributes to the tilting behavior. This is essential for safety, steerability and comfort.

Preferably a tiltable vehicle wherein a the inputs for the tilting control system further comprise driving speed and/or lateral acceleration of the vehicle and/or steering torque of the steering wheel and/or yaw angle of the vehicle and/or pressure of the tires and/or stiffness of the suspension and/or center of gravity of the vehicle, structure and irregularities of the surface where the wheels of the vehicle will provide friction. These inputs will make the vehicle more stable and therewith as well the steerability and the stability and safety of the vehicle.

In a second aspect of the present invention a steering mechanism for a tilting vehicle is provided, comprises a single sided suspension arm connected to the front frame by the means of an upper and lower link above the horizontal center plane of the front wheel, wherein the suspension arm is positioned under an angle between 40-50 degrees with respect to the horizontal center plane and wherein a steering box is integrated with the suspension arm, wherein the steering box comprises a steering box reduction, wherein the steering box reduction is connected to the steering wheel by means of the steering shaft and to the wheels by means of a steering rod, wherein the steering box reduction is configured to provide a steering reduction between the steering wheel and the steering rod and/or pitman arm. This is an optimal solution to obtain a bump steer free steering mechanism for a three wheeled tiltable vehicle.

Preferably, to transfer the rotational displacement of the steering wheel into a steering motion of the front wheel the steering box has been integrated in the suspension arm. The housing of the steering box (worm wheel housing) is an integral part of (for example the cast aluminum) suspension arm. The steering box itself basically consists of a wormshaft and a wormwheel that allow for a steering reduction such that the steer input from the driver is similar to that for an ‘average’ passenger car. Preferably shim(s) are provided in between the wormshaft housing and the integrated wormwheel housing.

Since the steering box is moving together with the suspension arm, the distance between the pitman arm that is connected to the wheel suspension element through the means of the draglink/steering rod, and the wheel suspension element does not vary with the suspension stroke. As such bump steer free steering is achieved.

The distance between the wormshaft and the steering shaft varies with the suspension stroke. This variation is taken by a telescopic steering column containing the steering shaft that connects the wormshaft directly to the steering wheel or to the output shaft of the EPAS. This telescopic shaft should enable a translation between one the upper and lower universal joint, yet it should be able to transfer the steering torque from the driver to the wormshaft. This has been realized by a splined shaft.

The steer-axis is built by the lower ball-joint in the suspension arm and the upper ball-joint in the wheel suspension support that connects the wheel suspension element with the suspension arm. These ball-joints are located in the longitudinal vertically orientated center plane of the front wheel. The relative longitudinal position of the lower ball-joint versus the upper ball-joint determine the caster angle.

For testing purposes the caster angle can easily be adjusted by changing the length of the wheel suspension support.

The bottom of the shock absorber is connected to the lower link, whereas the top of the shock absorber is connected to the chassis.

The steering mechanism according to the present invention consists of a single sided suspension arm that is under positioned under a near 45 degree angle relative to horizontal plane formed between the three wheels of the vehicles and therefore allowing for a narrower build envelope. The suspension arm is attached to the vehicle chassis by the means of an upper and lower link well above the horizontal center plane of the front wheel. By doing so there is plenty of room for the driver to position his feet. The attachments of the upper and lower link to the suspension arm on one side and to the chassis on the other side are chosen such (optimum point of “instantaneous point of rotation” of the upper and lower link with respect to the center of gravity of the vehicle) that the desired anti-dive can be realized.

In a third aspect of the present invention a steering mechanism for a vehicle, in particular tiltable and/or motorized according to any of the preceding claims 1-14 according to the present invention, wherein a steering mechanism is provided and which is connected and/or connectable to at least the front frame section and which is configured to steer the front wheel with respect to at least one front wheel axis and in particular the front wheel axis essentially vertical with respect to the surface where the front wheel is connected or connectable with the ground surface, wherein said steering mechanism comprises at least one steering element, in particular at least one steering wheel, wherein the steering mechanism comprises at least one suspension arm, wherein the suspension arm is connected and/or connectable to the front wheel by an wheel suspension element and on the other side connected and/or connectable to the front frame, wherein the steering mechanism is mechanically or electronically connected and/or connectable to the steering wheel (116) and on the other end rotatably connected and/or rotatably connectable to the wheel suspension element via at least a steering rod, wherein the steering mechanism is configured to transform the angular displacement of the steering wheel (116) in an angular displacement of the front wheel with respect to at least one front wheel axis, wherein the steering mechanism is configured to actuate the steering rod.

This vehicle with this type of steering mechanism prevents bump steer during driving and prevents scenario's which can lead to dangerous situations. Therefor this inventions overcomes the bump steer problem and especially for vehicles with electronically controlled tilting of the front frame. Thus steering mechanism could be applied as well to various tiltable vehicles and non-tiltable vehicles.

### DETAILED DESCRIPTION OF THE DRAWINGS

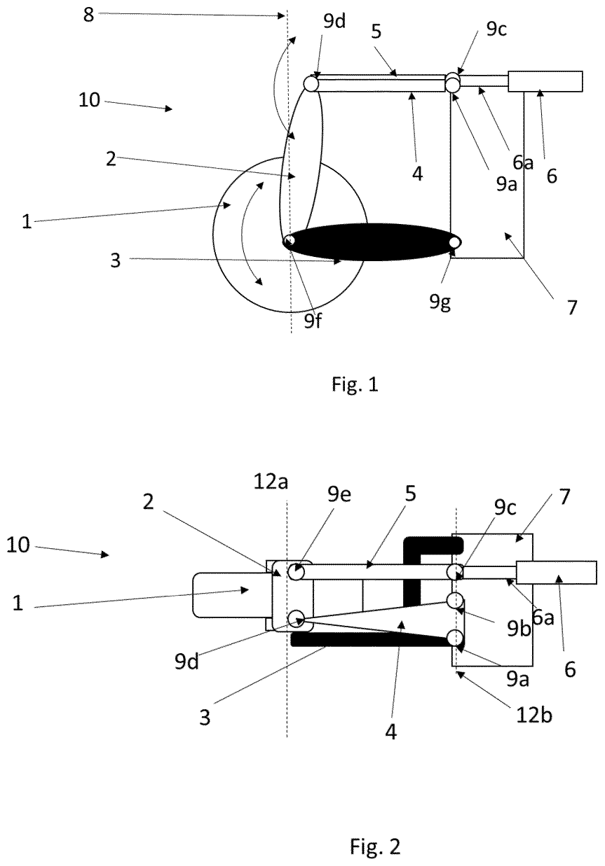

FIG. 1 shows a side view of a first embodiment of the state of the art when driving straight

FIG. 2 shows a top view of the first embodiment of the state of the art when driving straight

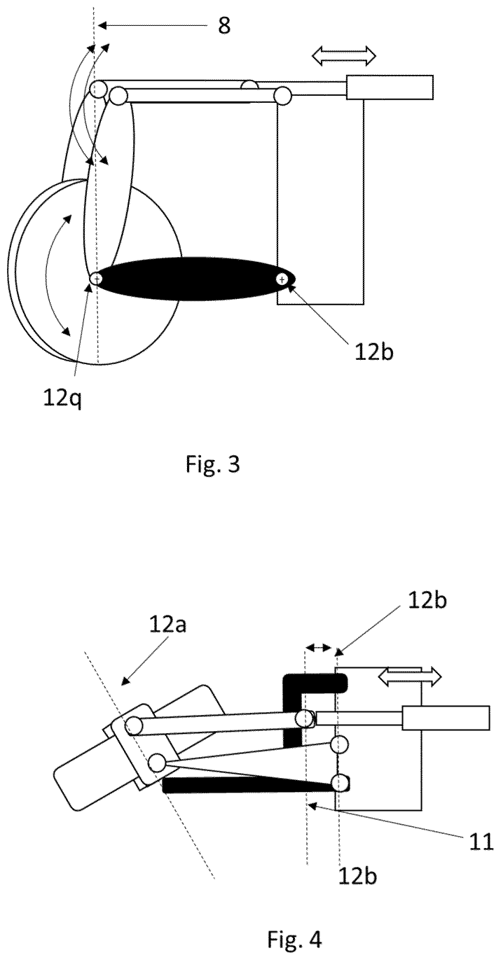

FIG. 3 shows a side view of the first embodiment of the state of the art when driving in a corner

FIG. 4 shows a top view of the first embodiment of the state of the art when driving in a corner FIG. 1 shows a side view of a first embodiment of the state of the art when driving straight

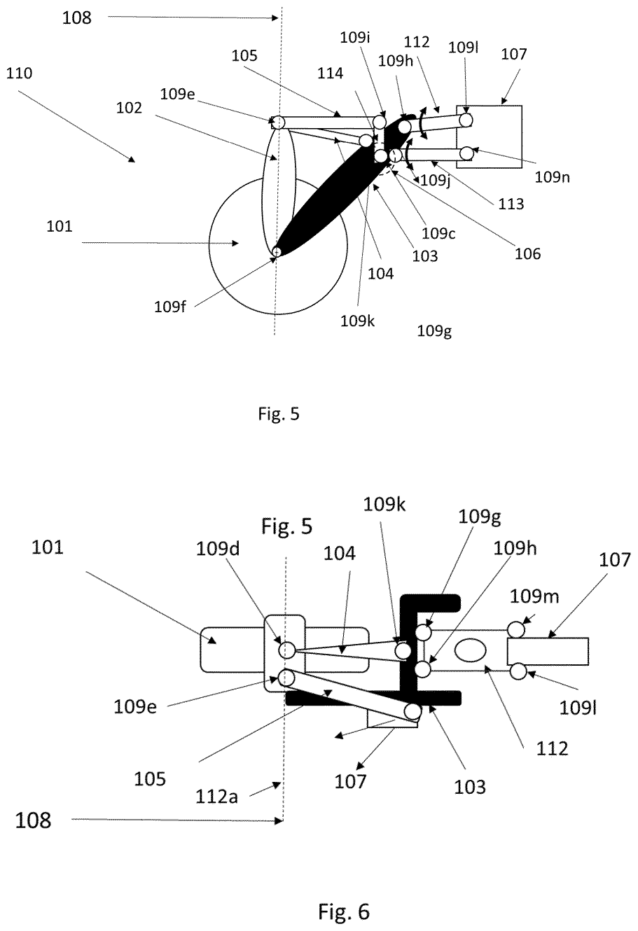

FIG. 5 shows a side view of a first embodiment of the present invention when driving straight

FIG. 6 shows a top view of the first embodiment of the present invention when driving straight

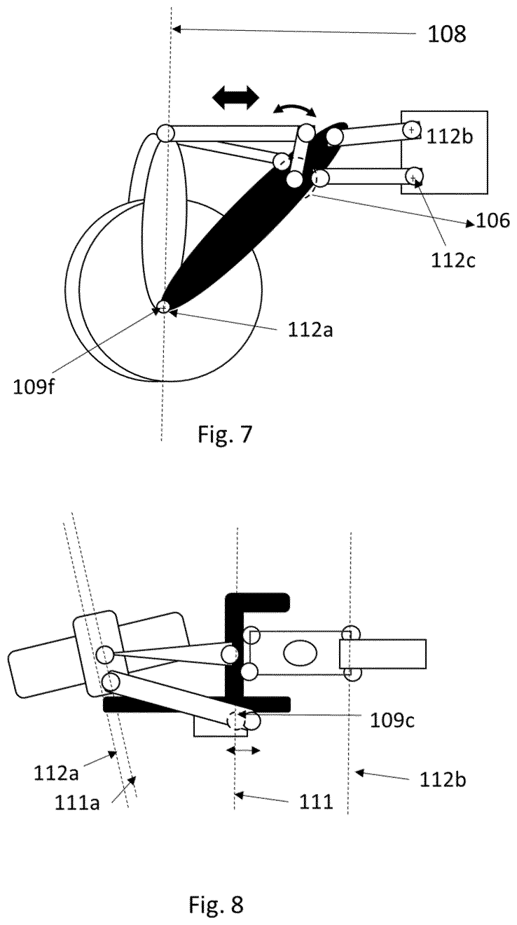

FIG. 7 shows a side view of the first embodiment of the present invention when driving in a corner

FIG. 8 shows a top view of the first embodiment of the present invention when driving in a corner

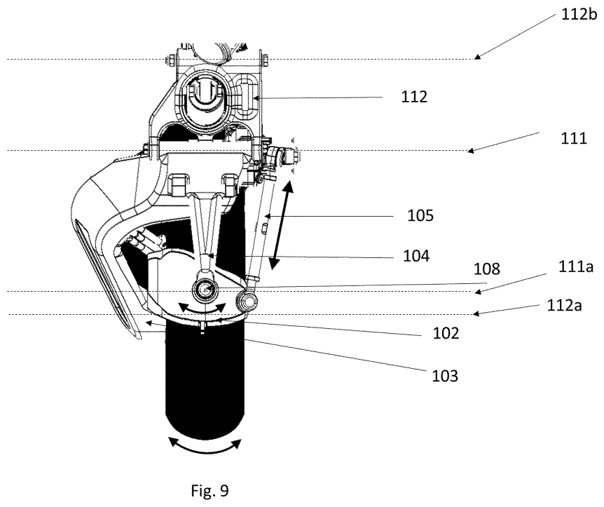

FIG. 9 shows a top view of an embodiment of the present invention

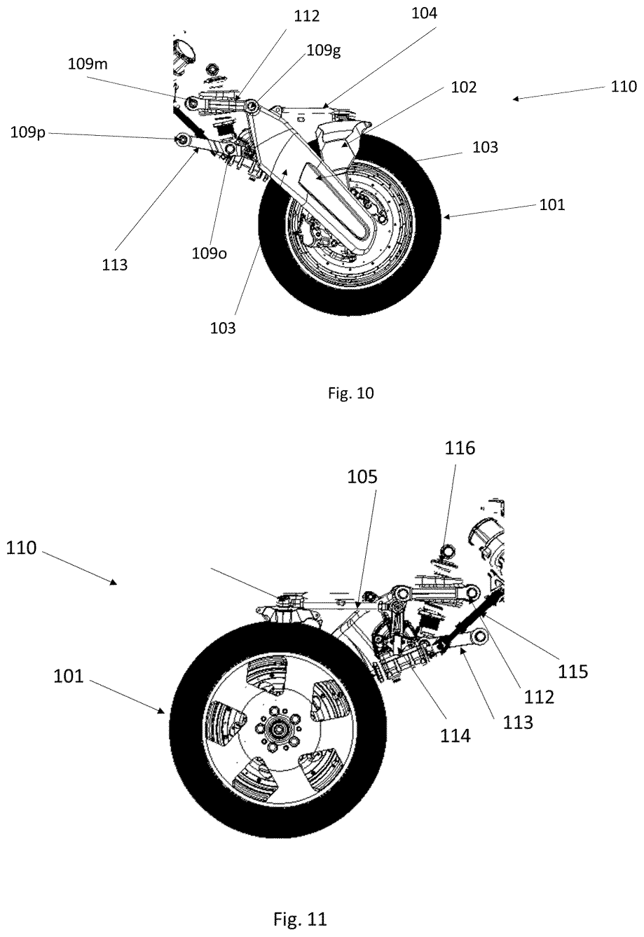

FIG. 10 shows a right side view of an embodiment of the present invention

FIG. 11 shows a left side view of an embodiment of the present invention

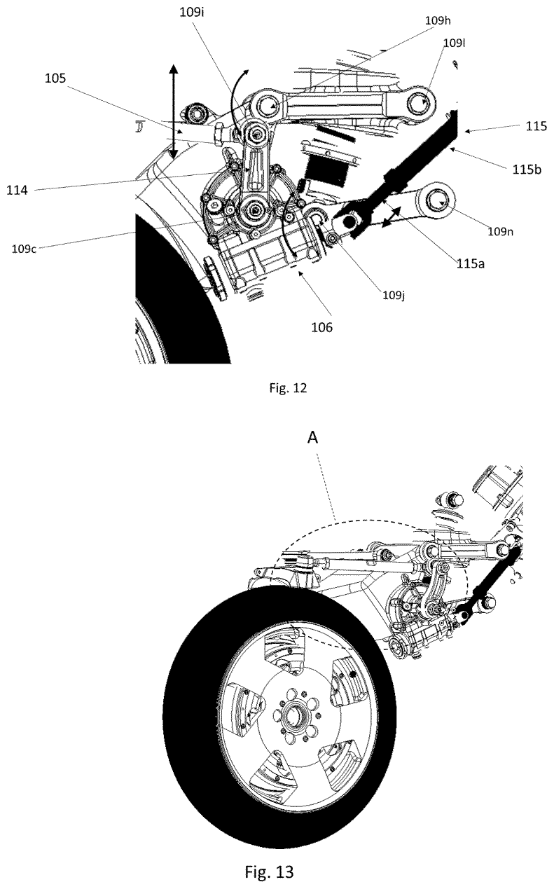

FIG. 12 shows a more detailed side view of the steering actuation unit as integrated part of the suspension arm

FIG. 13 shows a first three dimensional side view of the present invention

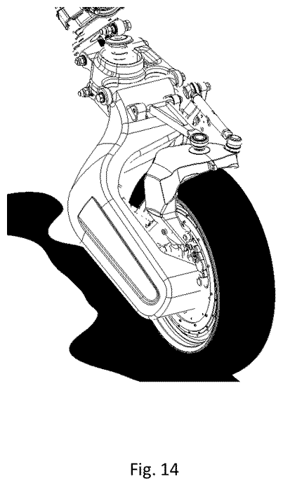

FIG. 14 shows a second three dimensional side view of the present invention

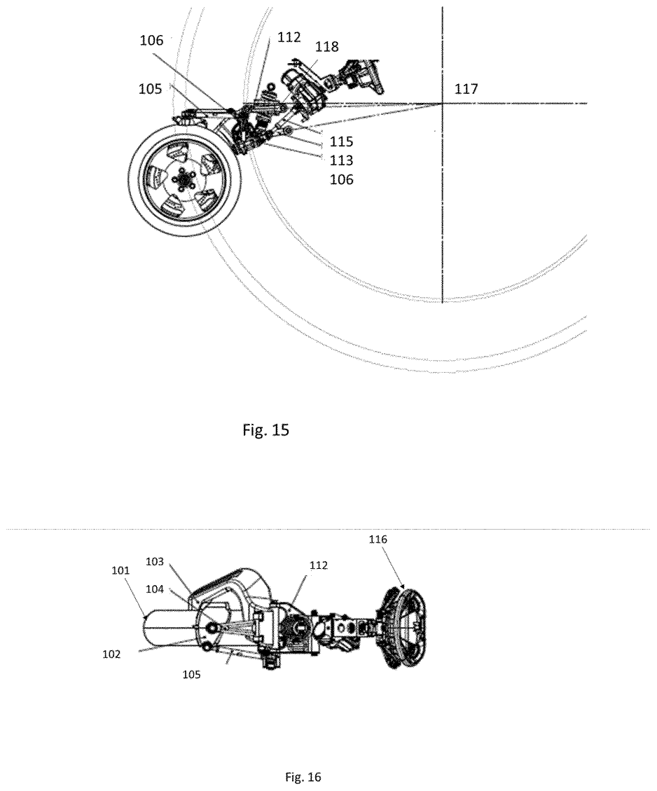

FIG. 15 shows a side view of an embodiment according to the present invention when driving straight similar to FIG. 11

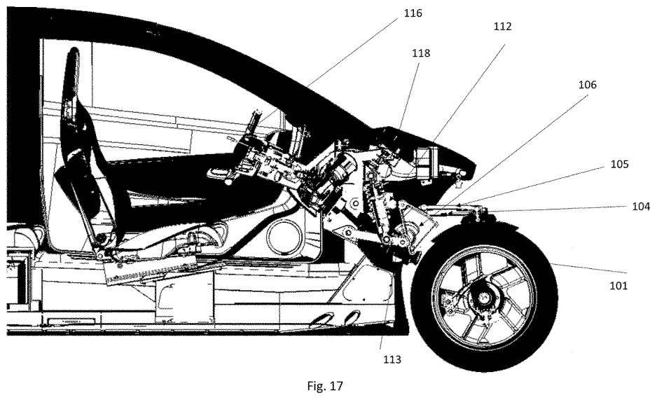

FIG. 16 shows a side view of an embodiment according to the present invention when driving straight similar to FIG. 9

FIG. 17 shows a section view of the front part of the three wheeled vehicle according to the present invention.

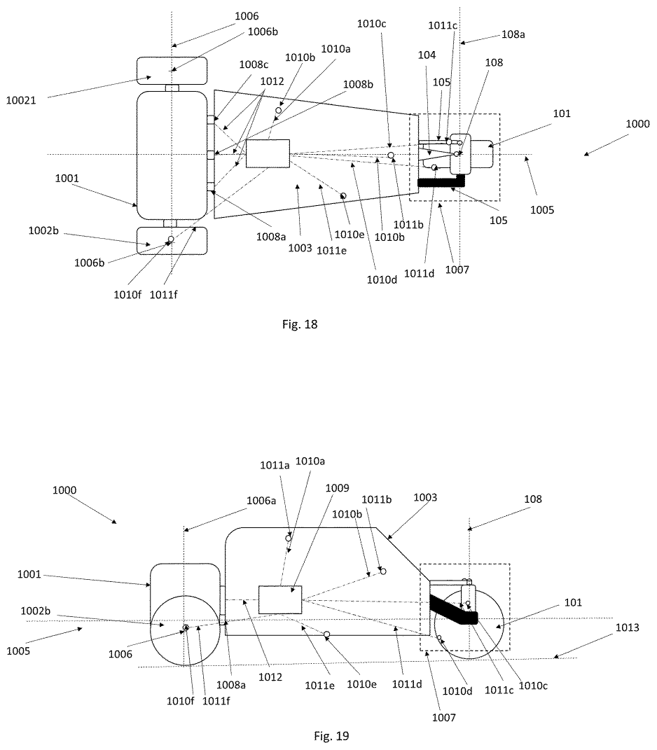

FIG. 18 shows an schematic top view representation of the three wheeled vehicle according to the present invention

FIG. 19 shows an schematic side view representation of the three wheeled vehicle according to the present invention

It is noted that the figures are only schematic representations of embodiments of the invention that are given by way of non-limiting example. In the figures, the same or corresponding parts are designated with the same reference numerals.

FIGS. 1-4 are showing a schematic representation of a front wheel steering mechanism of a three wheeled vehicle according to the state of the art.

FIGS. 1 and 2 are showing respectively side and top views of the first embodiment of the state of the art when driving straight. The schematic representation shows a the front wheel steering mechanism 10 includes a front wheel 1, an wheel suspension element 2, suspension arm 3, wheel suspension support 4, steering arm/steering rod 5, steering actuation unit 6. The wheel suspension element 2 is an element into which the front wheel 1 is rotatably connected. The Suspension arm 3 is connected on one side to a chassis 7 of the vehicle and on the other side connected to the wheel suspension element 2, wherein the suspension arm is preferably connected by means of joints 9f and 9g which are ball bearings. The wheel suspension element is kept in place by means of an wheel suspension support 4 which is connected to the wheel suspension element on one side and to the chassis 7 on the other side, wherein the wheel suspension support 4 is preferably connected by means of joints 9a, 9b and 9d which are ball bearings. The wheel suspension element 2 is preferably positioned under and angle with respect to the axis around which the wheel 1 is turning. This creates a certain caster angle where the caster angle also determines how sensitive the steering behavior is controlled by the driver via a steering wheel 116. The wheel suspension element 2 s further connected to a steering rod 5 and the steering actuation unit 6, preferably by means of joints 9c and 9e which are a ball joints, wherein the steering rod 5 is movable in longitudinal direction in order to turn the front wheel 1 about the steering axis 8. The front wheel steering mechanism for a three wheeled tilting vehicle of the state of the art as described above has a first suspension axis 12a and a second suspension axis 12b as shown in FIGS. 2 and 4. The first suspension axis 12a is formed by the connection of the suspension arm 3 with the wheel suspension element 2. The second suspension arm 12b is formed by the connection of the suspension arm 3 with the chassis 8.

FIG. 4 shows that the rotational axis of the steering rod 5 at joint 9c where it connects with the steering actuation unit and the rotational axis of the steering rod 5 at joint 9e where it connects with the wheel suspension element 2 are moved in longitudinal direction in relation to the second suspension axis 12b.

FIGS. 3 and 4 are showing top and side views of the first embodiment of the state of the art when driving in a corner. In these FIGS. 3 and 4 it is shown that the front wheel 1 has turned to the left, wherein the steering actuation unit 6 has actuated the steering rod 5 forward in longitudinal direction by means of a steering lever 6a (mounted on the chassis). The arrow above the steering actuation unit in FIG. 3 shows the direction of the movement as generated by the steering actuation unit 6. In relation to the state where the vehicle is driving straight, the state where the vehicle is driving in a corner with a front wheel 1 turning under an angle around the front wheel axis 8 as shown in FIGS. 3 and 4 (resulting in the front wheel turning the vehicle to the left or to the right), the steering rod has been moved in longitudinal direction including the joint 9c, wherein the joint c is connected to the chassis via e.g. a steering lever which is part of the steering mechanism. The rotation of the steering lever 6a (while steering), moves the steering rod 5 with its rotational axis 11 out of second suspension axis 12b where this offset with respect to the suspension axis 12b causing bump steer since the wheel can move in undesired directions in the state according to FIGS. 3 and 4 when driving e.g. in a rut or pothole and causing the steering wheel 116 to direct in undesired directions resulting in an unsafe and unstable steering behavior and feeling.

FIGS. 5-8 are showing a schematic representation of a front wheel steering mechanism of a three wheeled vehicle according to the state of the art.

FIGS. 5 and 6 are showing respectively side and top views of the first embodiment of the state of the art when driving straight. The schematic representation shows a steering mechanism 110 for a tiltable three wheeled vehicle comprising a front wheel 101, an wheel suspension element 102, suspension arm 103, wheel suspension support 104, steering arm/steering rod 105, pitman arm 114, steering actuation unit 106, upper link 112 and lower link 113.

The wheel suspension element 102 is an element into which the front wheel 101 is rotatably connected. The suspension arm 103 is connected on one side to a chassis 107 of the vehicle and on the other side connected to the wheel suspension element 102, wherein the suspension arm 103 is preferably connected by means of joints 109f to the wheel suspension element and on the other side rotatably connected by means of bearings 109g, 109h and 109j (and one joint of the lower link is not visible in the figures) which are bearings to respectively the lower link 112 and the upper link 113, wherein the upper link is preferably a bit longer than the lower link. The suspension with these upper and lower links 112 and 113 enables to tune the amount of dive to present in the vehicle. The lower link 113 and upper link 112 are on the other side rotatably connected to the chassis 107 by means of respectively joints 1091, 109m and 109n (one joint of the lower link is not visible in the figures), preferably bearings.

An wheel suspension support 104 keeps the wheel suspension element 102 in position by rotatably connecting the wheel suspension element to the suspension arm 103 on via a joint 109k, preferable ball joints. On the other side the wheel suspension support is connected to the wheel suspension element 102 by means of a joint 109d, preferably a ball joint. The position of the wheel suspension element 102 is chosen such, preferably where the axis about which the front wheel 101 turns with respect to the wheel suspension element 102, is placed under a certain angle with respect to the wheel axis 108 about which the front wheel 101 turns. This angle is the caster angle and this determines how sensitive and direct the driver is able to steer the vehicle. A too little caster angle leads to instable behavior of the vehicle.

The steering rod 105 is rotatably connected on one side via a joint 109e, preferably a ball joint, to the wheel suspension element 102. On the other side the steering rod is rotatably connected to a pitman arm 114 via a ball joint 109i. The pitman arm 114 rotatably connects the steering rod to the steering actuation unit 106, also called the steering box, by means of joint 109c, preferable a ball bearing. The pitman arm 114 is driven by e.g. a worm wheel which is e.g. supported by an electric power steering (EPS) and configured to pivot and pull or push the steering rod 105 in longitudinal/axial direction back and forward in order to turn the front wheel 101 about its axis 108. The position of the joint 109c does not change in relation to the suspension axis 109f, 109g, 109h, 109l, 109m, 109 n (two bearings of the lower links are not shown), because it doesn't move in relation to the suspension arm since the steering actuation unit 106 and the rotational axis 109c is connected to the suspension arm 105.

FIGS. 7 and 8 are showing top and side views according to the present invention when driving in a corner. More specifically the front wheel 1 is turned to the left. The steering actuation unit 106 has pivoted the pitman arm 114 to about its axis 108 in clockwise direction and there with pulling the steering rod 105 in axial direction and therewith turning the wheel via the wheel suspension element 102 to the left. FIGS. 7 and 8 shows a suspension axis 112a formed by the connection of the suspension arm 103 to the wheel suspension element 102. The suspension axis 112b and 112c are formed by the rotatable bearing of the upper link 112 and lower link 113 connected to the chassis. FIG. 8 shows that when the steering rod has moved in axial direction a rotational axis 111 of the steering rod 105 is not changed in position with respect to the suspension axis 112a, 112b and 112c. This keeps bump steer from happening and thus a more stable and safe steering behavior is obtained.

FIGS. 9-14 represent embodiments of the present invention. The reference numbers as used in the figures are in line with the components as shown in the FIGS. 5-8.

FIGS. 11-13 shows a steering shaft 115 which is connected to the steering wheel 116 in the vehicle cabin and connects the steering wheel 116 to the steering actuation unit 106.

The steering shaft contains a sliding construction (so called I-shaft) to compensate the movement of the swing fork (and therefore the steering house) in relation to the fixed vehicle cabin when the front suspension is moving as a result of the suspension travel. The lower part 115a of the steering shaft is fixed to a steering house (axial movement) which is part of the steering actuation unit 106. The upper part 115b of the steering shaft 115 is fixed to cabin of the front frame (no axial movement)

Detail A in FIG. 13 shows the steering actuation unit comprises the steering house which is integrated in the swing fork and therefore an integrated part of the front suspension 112a, the suspension travel of the suspension does not impact the position of the steering rod 105. This integration of the steering mechanism including the steering rod 105 will lead to a constant position of the steering rod to the wheel suspension element and avoid causing bump steer. FIG. 14 is the embodiment as shown in the FIGS. 9-13, but than in another three dimensional perspective.

FIGS. 15 to 17 are the same embodiments as illustrated in the other figure of the present invention, but then a slightly other representation.

FIGS. 18 and 19 show a side and top view of a simplification and abstract representation of the three wheeled vehicle (1000) including a rear frame (1001) section having two steerable or non-steerable (rear) wheels (1002a and 1002b) and a front frame section (1003) having at least one front wheel (101), wherein the front frame section (1003) is connected and/or connectable to the rear frame section (1001) via a connection (1004) which is configured to tilt the front frame section about a tilt axis (1005) in longitudinal direction of the front frame section (1003), wherein the rear frame section (1001) comprising rear wheels (1002a and 1002b) which are preferably steerable about a rear wheel steering axis (1006) or each rear wheel is steerable about its wheel axis (1006 1006b).

FIGS. 18 and 19 further illustrate the control unit (1009) the inputs (1011a; 1011b; 1011c; 1011d;, 1011e;, 1011f) comprising e.g. sensors (1010a, 1011a; 1010b, 1011b; 1010c, 1011c; 1010d, 1011d; 1010e, 1011e; 1010f, 1011f) which are in electronic of mechanical communication with the control unit and wherein the control unit (1009) is configures to transform the measure /puts/ signals in an optimal output control signal (1012) to optimally control the titling behavior at a certain speed and/or steering angle and/or lateral acceleration of the front frame and/or acceleration/deceleration of the vehicle and/or certain yaw angle and/or steering torque and/or steering angle of the front wheel and/or steering angle of the steering wheel and/or external data from external data providers and/or data obtain by sensor about the condition of the surface over which the wheels of the vehicles will drive etc.

For the purpose of clarity and a concise description, features are described herein as part of the same or separate embodiments, however, it will be appreciated that the scope of the invention may include embodiments having combinations of all or some of the features described. It may be understood that the embodiments shown have the same or similar components, apart from where they are described as being different.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

Many variants will be apparent to the person skilled in the art. All variants are understood to be comprised within the scope of the invention defined in the following non-limitative claims.

1. A vehicle (1000), comprising
a rear frame (1001) section comprising at least two rear wheels (1002a, 1002b) and at least one rear wheel axis (1006,1006a,1006b);
a rear frame (1003) section comprising at least one front wheel (101) and at least one front wheel (101) axis (108, 108a);
wherein the rear frame (1003) section is connected and/or connectable to the rear frame (1001) section via at least one connection (1008a, 1008b, 1008c);
a steering mechanism (1007) which is connected and/or connectable to at least the rear frame (1003) section and which is configured to steer the front wheel (101) with respect to at least one front wheel axis (108,108a), wherein said steering mechanism (1007) comprises at least one steering element (116);
wherein the steering mechanism (1007) comprises at least one suspension arm (103), wherein the suspension arm (103) is connected and/or connectable to the front wheel (101) by an wheel suspension element (102) and on the other side connected and/or connectable to the rear frame (1003);
wherein the steering mechanism (1007) is mechanically or electronically connected and/or connectable to the steering element (116) and on the other end rotatably connected and/or rotatably connectable to the wheel suspension element (102) via at least a steering rod (105), wherein the steering mechanism (1007) is configured to transform the angular displacement of the steering element (116) in an angular displacement of the front wheel (101) with respect to at least one front wheel (101) axis, wherein the steering mechanism (1007) is configured to actuate the steering rod (105), wherein the steering rod (105) is movable and/or rotatably connected and/or movable and/or rotatably connectable to the suspension arm (103).

2. A vehicle (1000) according to claim 1, wherein the vehicle (1000) is tiltable with respect to the at least one tilting axis (1005) and in particular configured for moving at least one person

3. A vehicle (1000) according to claim 1 or 2, wherein said at least two rear wheels (1002a, 1002b) are steerable with respect to at least one rear wheel axis (1006,1006a, 1006b).

4. A vehicle (1000) according to claim 1 or 2, wherein the rear frame (1003) section is configured to tilt the rear frame (1003) section about at least one tilting axis (1005) in particular in longitudinal direction of the rear frame (1003) section.

5. A vehicle (1000) according to claim anyone of the preceding claims, wherein comprising at least one control unit (1009) which is configured to electronically control the tilting behavior of the front frame section (1003), and/or wherein the control unit is configured to control the degree of tilting by the control system in particular by one or more inputs (1010a, 1011a; 1010b, 1011b; 1010c, 1011c; 1010d, 1011d; 1010e, 1011e; 1010f, 1011f), wherein at least one of the inputs is chosen from steering angle of the front wheel (101) about its axis (108) and/or the steering angle of the steering element (116) and/or the steering torque applied to the steering element (116)

6. A vehicle (1000) according to claim anyone of the preceding claims, wherein the suspension arm (103) is a double sided suspension arm or single side suspension arm (103).

7. A vehicle (1000) according to anyone of the preceding claims, wherein the wheel suspension element (102) is connected and/or connectable to the rear frame (1003) by the means of an upper (112) and/or lower link (113) in particular above the horizontal center plane of the front wheel (101), wherein the upper link (112) and lower link (113) are preferably rotatably connected and/or rotatably connectable to the rear frame (1003) and the suspension arm (103)

8. A vehicle (1000) according to claim anyone of the preceding claims, comprising at least one wheel suspension support (104) is provided which rotatably connects and/or which is rotatably connectable between the wheel suspension element (102) and the suspension arm (103)

9. A vehicle (1000) according to claim anyone of the preceding claims, further comprising at least one steering shaft (115) which is connected and/or connectable, in particular mechanically or electronically connected and/or connectable to the steering element (116) and on the other end rotatably connected and/or rotatably connectable to the wheel suspension element (102) element preferably via the steering rod (105), wherein the steering mechanism (1007) is configured to actuate the steering rod (105) and steering shaft, wherein the steering shaft (115)and steering rod (105) are movable or rotatably connected and/or movable or rotatably connectable to the suspension arm (103).

10. A vehicle (1000) according to claim anyone of the preceding claims, wherein the steering rod (105) is rotatably connected to the suspension arm (103) by means of an pitman arm (114), wherein the steering rod (105) is actuated and/or actuatable by means of at least one pitman arm (114), wherein the pitman arm (114) is rotatably connected and/or connectable to the steering rod (105) and rotatably connected and/or connectable to the suspension arm (103).

11. A vehicle (1000) according to claim anyone of the preceding claims, wherein the steering rod (105) and pitman arm (114) are actuated by means of an steering actuation unit (106).

12. A vehicle (1000) according to claim anyone of the preceding claims, wherein the suspension arm (103) is positioned under an angle between 40-50 degrees with respect to a surface (1013) formed by the lowest points of the front and rear wheels (1002a, 1002b) and preferably under an angle of 45 degrees with respect to the a the surface formed by the lowest points of the front wheel (101) and rear wheels (1002a, 1002b).

13. A vehicle (1000) according to claim anyone of the preceding claims, wherein the steering actuation unit (106) comprises a steering box (106a), wherein the steering box (106a) is integrated with the suspension arm (103), wherein the steering box (106a) comprises a steering box reduction, wherein the steering box reduction is connected to the steering element (116) and to the front wheel (101) by means of the steering shaft (115), wherein the steering box reduction is configured to provide a steering reduction between the steering element (116) and the steering rod (105) or between the steering element (116) and the steering rod (105) via the pitman arm (114).

14. A vehicle (1000) according to claim 14, wherein the steering box (106a) reduction comprises a wormshaft and a wormwheel

15. A vehicle (1000) according to anyone of the preceding claims 9-14, wherein at least part of the steering shaft (115) is telescopic

16. A vehicle (1000) according to claim 14, wherein the telescopic steering shaft (115) connects the wormshaft directly to the steering element or to the output shaft of in particular an electric powered assisted steering system (EPAS)

17. A vehicle (1000) according to anyone of the preceding claims, wherein the steering rod (105) is connected to the front wheel (101) or wheel suspension element (102) by means of an ball joint and to the suspension arm (103) by means of a ball joint, wherein optionally one of the two ball joints is an upper ball joint and the other ball joint the lower ball joint, wherein the relative longitudinal position of the lower ball-joint versus the upper ball-joint determines the caster angle.

18. A vehicle (1000) according to anyone of the preceding claims, wherein the upper link (112) and lower link (113) have are positioned such that they having a joint ‘instantaneous center of rotation’

19. A vehicle (1000) according to anyone of the preceding claims, wherein the upper link (112) and lower link (113) have a different length

20. A vehicle (1000) according to anyone of the preceding claims, wherein the upper link (112) is shorter than the lower link (113).

21. A vehicle (1000) according to anyone of the preceding claims, wherein the lower link (113) is connected via shock absorber (118) to the rear frame (1003) of the vehicle (1000)

22. A vehicle (1000) according to anyone of the preceding claims, wherein a the inputs (1010a, 1011a; 1010b, 1011b; 1010c, 1011c; 1010d, 1011d; 1010e, 1011e; 1010f, 1011f) for the tilting control system further comprise driving speed and/or lateral acceleration of the vehicle (1000) and/or steering torque of the steering element and/or yaw angle of the vehicle (1000) and/or pressure of the tires and/or stiffness of the suspension and/or center of gravity of the vehicle (1000), structure and irregularities of the surface where the wheels of the vehicle (1000) will provide friction

23. A steering mechanism (1007) for a vehicle (1000) or tiltable vehicle (1000) according to any of the preceding claims, wherein
the steering mechanism (1007) which is connected and/or connectable to at least the rear frame (1003) section and which is configured to steer the front wheel (101) with respect to at least one front wheel (101) axis, wherein said steering mechanism (1007) comprises at least one steering element (116);
wherein the steering mechanism (1007) comprises at least one suspension arm (103), wherein the suspension arm (103) is connected and/or connectable to the front wheel (101) by an wheel suspension element (102) and on the other side connected and/or connectable to the rear frame (1003);
wherein the steering mechanism (1007) is mechanically or electronically connected and/or connectable to the steering element (116) and on the other end rotatably connected and/or rotatably connectable to the wheel suspension element (102) via at least a steering rod (105), wherein the steering mechanism (1007) is configured to transform the angular displacement of the steering element (116) in an angular displacement of the front wheel (101) with respect to at least one front wheel (101) axis, wherein the steering mechanism (1007) is configured to actuate the steering rod (105), wherein the steering rod (105) is movable and/or rotatably connected and/or movable and/or rotatably connectable to the suspension arm (103).
